(19) United States
(12) Patent Application Publication
(10) Pub. No.: US 2025/0168428 A1
(43) Pub. Date: May 22, 2025

(54) SYSTEM AND METHOD FOR DISTRIBUTING VIDEO DATA FROM A SECURE VIDEO SOURCE NETWORK

(71) Applicant: Skyline Technology Solutions, LLC, Glen Burnie, MD (US)

(72) Inventor: Michael Robert BRANAN, Columbia, MD (US)

(73) Assignee: Skyline Technology Solutions, LLC, Glen Burnie, MD (US)

(21) Appl. No.: 18/512,729

(22) Filed: Nov. 17, 2023

(51) Int. Cl. H04N 21/239; H04N 21/2187; H04N 21/2343; H04N 21/258; H04N 21/437

(52) U.S. Cl. CPC H04N 21/2393; H04N 21/2187; H04N 21/234309; H04N 21/25875; H04N 21/437

(57) ABSTRACT

A secure video transmission system and method comprises a secure network that is connected to a distribution network through a firewall. The secure network is adapted to transmit video data to the distribution network that can in turn transmit the video data to an end user after receiving a request for video URL. Video data can be accessed by an external user without directly accessing the video data sources. The firewall does not permit any devices in the distribution network to initiate a connection to any devices on the secure network.

### TECHNICAL FIELD

Disclosed embodiments are generally related to secure network access, and in particular to accessing video data on a secure network by an external party without compromising security.

### BACKGROUND

Modern security systems often rely on Internet Protocol (IP) camera networks to provide real-time video surveillance. For enhanced security, these IP camera networks are deployed within restricted or isolated networks, ensuring that live video streams are accessible only to authorized users of the restricted networks. However, the need to share live video from such restricted camera networks with external parties, such as law enforcement agencies or third-party security providers, presents a challenge with respect to maintaining security.

Traditionally, video distribution servers utilize common streaming protocols, such as Real-Time Streaming Protocol (RTSP) or Real-Time Messaging Protocol (RTMP), to access live video from cameras. These protocols require firewall rules to be opened, allowing the distribution server to establish a connection with the cameras in the secure network. Unfortunately, this approach introduces potential security vulnerabilities, as a compromised distribution server could be used as a jumping point to gain unauthorized access to the secure camera network.

Therefore, there is a need to be able to provide access to the cameras within the secure network without compromising the security of the cameras.

### SUMMARY

Briefly described, aspects of the present disclosure relate to a system and method for accessing video data on a secure network from an external network without compromising the secure network.

An aspect of the present disclosure is a secure video data network system. The network system comprising: a secure network comprising at least one video source and an ingestion node, wherein the ingestion node is adapted to normalize video data generated by the at least one video source and generate a user datagram protocol/real-time transport protocol (UDP/RTP) video stream and session description protocol (SDP) file; and a distribution network comprising at least one distribution node operably connected to the secure network, wherein the SDP file and the UDP/RTP video stream are received at the distribution node through a firewall, wherein an external user can access the UDP/RTP video stream from the distribution node through the firewall by transmitting a request video URL to the distribution node thereby permitting video data from the at least one video source to be viewed by the external user.

Another aspect of the present disclosure is a method for securely accessing video data. The method, comprising determining formats of video data from at least two video sources; normalizing the formats of the video data from the at least two video sources so that the normalized formats of the video data from the at least two video sources are the same; generating user datagram protocol/real-time transport protocol (UDP/RTP) video streams for the video data from the at least two video sources; transmitting the UDP/RTP video streams through a firewall to a distribution node on a distribution network; receiving a request from an external user through the firewall at the distribution node; and transmitting in response to the request from the external user at least one of the UDP/RTP video streams to the external user location.

### BRIEF DESCRIPTION OF THE DRAWINGS

FIG. 1 is a diagram showing the secure video transmission system for providing secure access to video sources.

FIG. 2 is a flow diagram showing the processing and transmission of the video data between the secure network and the distribution network.

FIG. 3 is a flow diagram showing the processing and transmission of the video data between the distribution network and an external party on an external network.

### DETAILED DESCRIPTION OF ILLUSTRATIVE EMBODIMENTS

In security setups for various environments and establishments live video streams are used to provide information to personnel authorized to access the live video streams. Internet Protocol (IP) cameras may be isolated or placed within a secure network to minimize the risk of unauthorized access to live video streams generated by the IP cameras. This disclosure addresses securely sharing video data, such as live video streams, from secure networks with external parties, while safeguarding the integrity of the secure network.

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art.

The components described hereinafter as making up the various embodiments are intended to be illustrative and not restrictive. Many suitable components that would perform the same or a similar function as the components described herein are intended to be embraced within the scope of embodiments of the present disclosure.

Turning to the issues presented when accessing video sources located on secure networks, the security concerns are addressed by providing a method for distributing video data, such as live video, from the secure network to an external user that is not in the secure network. An ingestion node is located within the secure network. In an embodiment, the ingestion node is a video ingestion/transcoding server. Using the ingestion node, video data from video sources can be normalized within the secure network and a User Datagram Protocol/Real-time Transport Protocol (UDP/RTP) stream transmitted from the ingestion node to a distribution network. The UDP/RTP stream enables distribution of video data to external users without direct communication between the distribution network and the video sources within the secure network. Furthermore, a distribution node is not required to initiate connection a ingestion node in order to receive video data

Reference will now be made to the figures wherein diagrams and flow charts of the system and method for providing access to the secure network is shown.

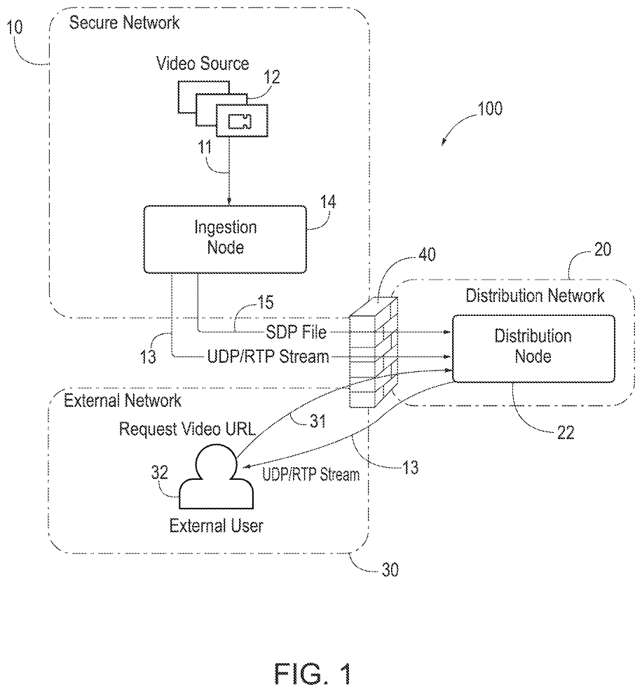

Turning to FIG. 1, shown is a diagram of the secure video transmission system 100 for providing secure access to video sources 12. FIG. 1 shows secure network 10 and distribution network 20. These networks form part of the secure video transmission system 100. External users 32 from the external network 30 can access the secure video transmission system 100.

In an embodiment, the secure network 10 comprises a plurality of video sources 12. Video sources 12 may be a device capable of capturing video and ultimately being able to transmit the captured video data via a networked system, either wirelessly and/or via a wired system. Some examples of video sources are IP cameras, IP video encoders, and Network Video Recorders (NVR). The video sources 12 may be adapted to transmit video data 11 using different protocols.

Video sources 12 may utilize various protocols for streaming video over the internet, each with its own advantages. One protocol is RTP, which enables communication between the camera and a viewer's device, allowing for low-latency, high-quality video streaming. Another option is HTTP/HTTPS, which provides easy access through web browsers and offers secure transmission via encryption. ONVIF (Open Network Video Interface Forum) is a standardized protocol that provides interoperability between different brands of cameras and recording devices, ensuring seamless integration within a surveillance system.

Some video sources support proprietary protocols developed by manufacturers to optimize performance and compatibility with their specific software and hardware ecosystem. The choice of protocol depends on factors like security requirements, compatibility with existing equipment, and the desired level of accessibility and control over the camera's stream on the internet.

Due to the potential presence of different types of protocols that may be used to transport the video data 11 in the secure network 10, a way of normalizing the video data 11 is provided. In the secure network 10 shown in FIG. 1, the video sources 12 transmit the video data 11 to the ingestion node 14. In an embodiment, ingestion node 14 is a video ingestion/transcoding server that can transcode the protocols. The ingestion node 14 establishes direct communication with the video sources 12.

The ingestion node 12 is adapted to normalize the video data 11. By normalizing the video data 11, the data from the video sources 12 is transcoded into the same protocol. Data that is already in the desired end protocol is not transcoded. The transcoding of the video data 11 is performed to achieve the desired encoding settings.

The ingestion node 12 generates UDP/RTP streams 13 from video data 11 that has been normalized by the ingestion node 12. By generating UDP/RTP streams 13, efficient, low-latency transmission of the video data 11 can be achieved. Once the UDP/RTP streams 13 are generated, the generated UDP/RTP streams 13 are sent to the distribution network 20 through a firewall 40. Firewall 40 is part of the secure video transmission system 100.

UDP is part of the internet transport layer and provides a connectionless, best-effort delivery service. Unlike protocols like TCP (Transmission Control Protocol), UDP does not establish a connection before sending data. It simply sends packets to the destination without prior setup. UDP generally has lower overhead costs to implement. UDP is faster and more efficient for certain types of applications. UDP supports broadcasting messages to multiple recipients (broadcast) and sending messages to a specific group of recipients (multicast).

RTP is a protocol used for transmitting real-time audio and video data over IP networks. It can work in conjunction with a protocol called RTCP (Real-time Transport Control Protocol) which handles control functions like monitoring the quality of the transmission. RTP is designed to carry real-time media streams, such as audio and video, from a source to a destination. RTP assigns a timestamp to each data packet, allowing the receiver to reconstruct the timing of the original media. This permits the synchronizing of audio and video streams. RTP packets contain information, such as, sequence numbers, timestamps, payload type, and synchronization source identifiers. This information aids in the proper processing of the media at the receiving end. RTP can operate on top of UDP to deliver timely and synchronized audio and video data.

Firewall 40 is a security mechanism that exists between the secure network 10 and the distribution network 20. In the embodiment shown in FIG. 1, the firewall 40 also exists between the distribution network 20 and the external network 30. The firewall 40 may be the same firewall for both flows of data, the flow between the secure network 10 and the distribution network 20 and the flow between the distribution network 20 and the secure network 10. In an embodiment, there can be a separate firewall 40 between the secure network 10 and the distribution network 20 and between the distribution network 20 and the secure network 10.

The firewall 40 may be hardware, software, or a combination of both, that acts as a protective barrier between a computer, network, or system and external networks. The firewall 40 oversees and regulates the flow of incoming and outgoing data packets based on predefined security rules. These rules dictate whether a packet is permitted or denied access to the respective networks. In determining whether to permit access, the firewall 40 considers factors like source, destination, port number, and protocol. In addition to packet filtering, in an embodiment, firewall 40 can control access to specific services or applications, allowing administrators to manage which resources can be accessed. In an embodiment, firewall 40 can perform Network Address Translation (NAT) to provide an extra layer of privacy. In an embodiment, the firewall 40 can incorporate Intrusion Prevention Systems (IPS) to actively monitor network activity for suspicious behavior. By maintaining logs of network traffic and providing alerts for unusual activity, firewall 40 can provide tools for analysis, auditing, and troubleshooting. Firewall 40 is able to provide an additional safeguard against unauthorized access, malware, and cyberattacks.

The ingestion node 12 is further adapted to post a Session Description Protocol (SDP) file 15 for each UDP/RTP stream 13. The ingestion node 12 sends the SDP file 15 through the firewall 40 to the distribution node 22 located in the distribution network 20. SDP files 15 contain information, such as the UDP ports for the UDP/RTP streams 13.

Another name for the distribution network 20 is demilitarized zone (DMZ). The distribution network 20 comprises at least one distribution node 22. The distribution node 22 is a server, or collection of servers that are adapted to receive the UDP/RTP streams 13. The distribution node 22 does not communicate directly with the video sources 12 that are located within the secure network 10. By not communicating directly with the video sources 12, potential security vulnerabilities are avoided.

The external network 30 comprises an external user 32. The external user requests access to one of the video streams 11 from the video sources 10. In an embodiment, the video stream 11 is a live video stream. In an embodiment, the video stream is previously recorded video stream. In an embodiment, the video stream is a combination of live and recorded video streams.

When an external user 32 requests access to a specific video stream 11 from the distribution node 22, the external user 32 transmits a request video URL 31 through the firewall 40. The distribution node 22 reads the SDP file 15 corresponding to the request video URL 11 to determine the UDP port with the UDP/RTP stream 13 for that video stream 11. The distribution node 22 opens a socket to listen on the determined UDP port to start receiving the UDP/RTP stream 13, which in an embodiment is a live video stream. The UDP/RTP stream 13 corresponds to the video data 11 from a video source 12.

The distribution node 22 securely transmits the video stream 11 to an authorized external user 32 without requiring direct communication with the video sources 12 in the secure network 10.

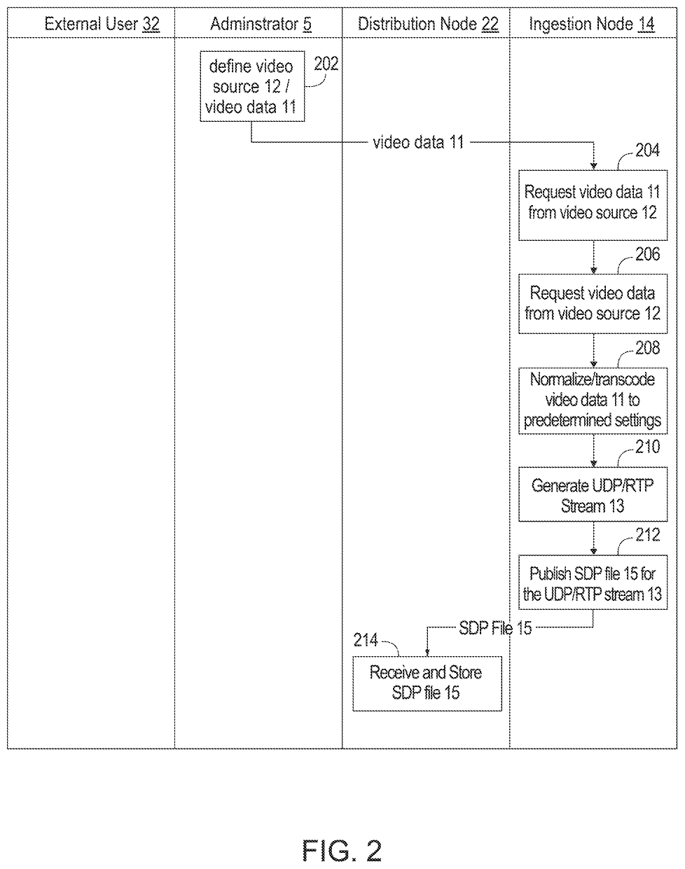

Turning to FIG. 2, shown is a flow chart showing the distribution of data from the secure network 10 to the distribution network 20.

In step 202, an administrator 5 of the secure video transmission system 100 defines a video source 12 and the video data 11 that comes from the video source 12. In an embodiment, the administrator 5 is part of the secure network 10. In an embodiment, the administrator 5 has access to the secure network 10. In an embodiment, the definitions are predefined by the secure video transmission system 100.

In step 204, the video data 11 is received at the ingestion node 14. As, discussed above, in an embodiment, the ingestion node 14 is a video ingestion/transcoding server that is adapted to transcode the video data 11. In step 206, video data 11 is requested from a video source 12.

In step 208, the video data 11 is normalized and/or transcoded to be at the desired and/or predetermined settings for use by secure video transmission system 100. In step 210, the normalized and/or transcoded video data 11 is used to generate the UDP/RTP stream 13 that will be accessible by an external user 32.

In step 212, the SDP file 15 is published by the ingestion node 14 and then transmitted to the distribution node 22 through a firewall 40 (shown in FIG. 1). In step 214, the SDP file 15 for the UDP/RTP stream 13 is stored at the distribution node 22.

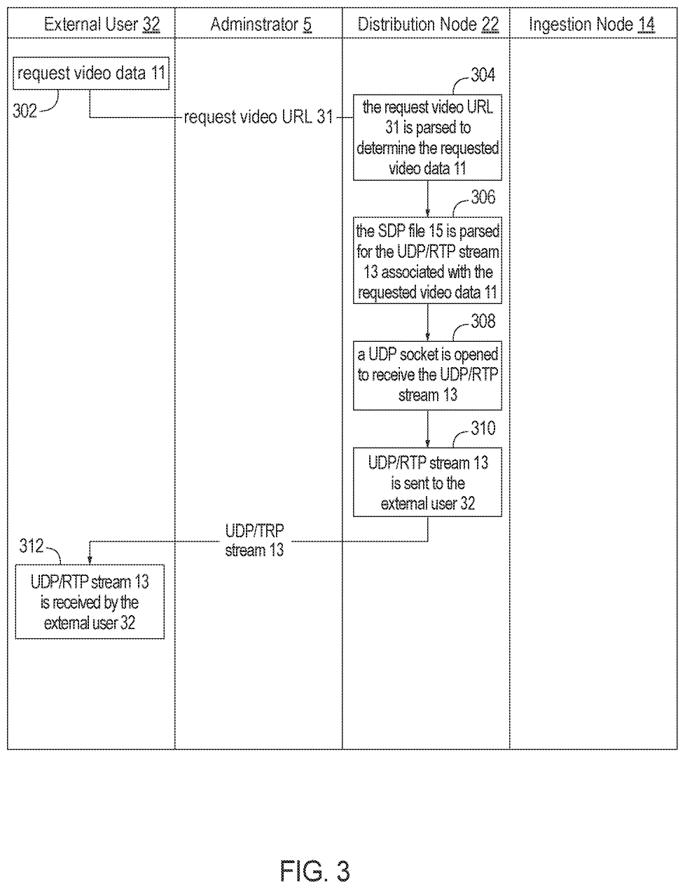

Turning to FIG. 3, shown is a flow chart showing the transmission of data from the distribution network 10 to the external network 30 and the external user 32.

In step 302, video data 11 from a video source 12 on the secure network 10 is requested by the external user 32 by transmitting, through firewall 40 (shown in FIG. 1), a request video URL 31 to the distribution node 22.

In step 304, the request video URL 31 is parsed to determine identity of the requested video data 11. In step 306, the SDP file 15 is parsed to determine the UDP/RTP stream 13 associated with the requested video data 11. In step 308, a UDP socket is opened to receive the UDP/RTP stream 13. In step 310, the UDP/RTP stream 13 is transmitted, through a firewall 40 (shown in FIG. 1), to external user 32. In step 312, the UDP/RTP stream 13 is received by the external user 32. The receipt of the UDP/RTP stream 13 by the external user 32 does not compromise the security of the secure network 10.

The system and method disclosed herein are useful in scenarios where secure live video sharing is wanted between different organizations or entities. It enables video sharing without exposing a secure network, such as a secure restricted camera network, to potential security risks. By preventing direct communication between the distribution node 22 and the video sources 12 on the secure network 10, the method reduces the risk of unauthorized access and potential hacking attempts.

The use of a distribution network 20 as a DMZ for the distribution node 22 ensures separation between the secure network 10 and the external 30 network, further enhancing security. The inclusion of an ingestion node 10, such as a video ingestion/transcoding server, allows the method to be retrofitted into legacy camera deployments, thereby providing compatibility and flexibility.

The method and system disclosed herein provide a solution for sharing video data, such as live video feeds, from secure networks, such as restricted IP camera networks, with external users. By deploying a video ingestion/transcoding server within the restricted network and streaming the video to the distribution node using a connectionless protocol, the method limits the exposure of the secure camera network while facilitating efficient and authorized video distribution. Additionally, the ingestion node 14 allows video to be “pushed” from the secure network 10 to the distribution node 22 rather than having the distribution node 22 request the video from the video source 12. The distribution node 22 on distribution network 20 does not initiate a connection to any video devices 12 on the secure network 10.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed:

1. A secure video transmission system comprising:
a secure network comprising at least one video source and an ingestion node, wherein the ingestion node is adapted to normalize video data generated by the at least one video source and generate a user datagram protocol/real-time transport protocol (UDP/RTP) video stream and session description protocol (SDP) file; and
a distribution network comprising at least one distribution node operably connected to the secure network, wherein the SDP file and the UDP/RTP video stream are received at the distribution node through a firewall, wherein an external user can access the UDP/RTP video stream from the distribution node through the firewall by transmitting a request video URL to the distribution node thereby permitting video data from the at least one video source to be viewed by the external user.

2. The transmission system of claim 1, wherein the distribution node comprises at least one server.

3. The transmission system of claim 1, wherein the ingestion node comprises at least one video ingestion/transcoding server.

4. The transmission system of claim 1, wherein there is at least one other video source, wherein the video data generated by the at least one video source and the at least one other video source are in different formats.

5. The transmission system of claim 1, wherein after the video data generated by the at least one video source and the at least one other video source is transmitted from the ingestion node, the video data generated by the at least one video source and the at least one other video source are in the same format.

6. The transmission system of claim 1, wherein the video data generated by the at least one video source is live video data, and the external user can view the live video data without directly accessing the secure network.

7. The transmission system of claim 1, wherein the distribution node does not directly communicate with the at least one video source.

8. The transmission system of claim 1, wherein the SDP file contains information regarding a UDP port for the UDP/RTP video stream.

9. The transmission system of claim 1, wherein the SDP file and the UDP/RTP video stream are transmitted from the ingestion node through the firewall to the distribution node.

10. The transmission system of claim 1, wherein the external user is an authorized external user.

11. A method for securely accessing video data, comprising:
determining formats of video data from at least two video sources;
normalizing the formats of the video data from the at least two video sources so that the normalized formats of the video data from the at least two video sources are the same;
generating user datagram protocol/real-time transport protocol (UDP/RTP) video streams for the video data from the at least two video sources;
transmitting the UDP/RTP video streams through a firewall to a distribution node on a distribution network;
receiving a request from an external user through the firewall at the distribution node; and
transmitting in response to the request from the external user at least one of the UDP/RTP video streams to the external user.

12. The method of claim 11, wherein the at least two video sources are within a secure network.

13. The method of claim 11, wherein normalizing the formats of the video data occurs at a video ingestion/transcoding server.

14. The method of claim 11, further comprising transmitting via the video ingestion/transcoding server on the secured network a session description protocol (SDP) file for the UDP/RTP video stream to the distribution node.

15. The method of claim 14, wherein the SDP file contains a UDP port for the UDP/RTP video stream.

16. The method of claim 15, wherein the SDP file and the UDP/RTP video stream are transmitted from the ingestion/transcoding server through the firewall to the distribution node.

17. The method of claim 11, wherein the request from the external user through the firewall is a request video URL.

18. The method of claim 11, wherein the distribution node does not initiate a connection with the secure network.

19. The method of claim 11, wherein the external user is an authorized external user.

20. The method of claim 11, wherein transmitting in response to the request from the external user at least one of the UDP/RTP video streams to the external user is through the firewall.
